(19) United States
(12) Patent Application Publication
(10) Pub. No.: US 2004/0034597 A1
(43) Pub. Date: Feb. 19, 2004

(54) System and method for managing micropayment transactions, corresponding client terminal and trader equipment

(76) Inventor: Alain Durand, Rennes (FR)

Correspondence Address: Joseph S Tripoli, Thomson Multimedia Licensing, Patent Operation, C N 5312, Princeton, NJ, 08543-0028, US

(21) Appl. No.: 10/332,158

(22) PCT Filed: Jul. 9, 2001
(86) PCT No.: PCT/FR01/02203

(30) Foreign Application Priority Data
Jul. 7, 2000 (FR) 00/08867

(51) Int. Cl. G06F 17/60

(52) U.S. Cl. 705/41

(57) ABSTRACT

The invention relates to a system and a process for managing micropayment transactions comprising at least one broker (1), at least one client (2) and at least one merchant of products and/or of services (3), said transactions implementing exchanges of tokens.

According to the invention, each of said clients (2) has available at least two first separate areas for storing tokens, corresponding to at least one main purse and to at least one secondary purse, said main purse being able to comprise tokens supplied by said broker (1) to said client (2), and said secondary purse being able to comprise tokens supplied by said at least one merchant (3) to said client (2).

### FIELD OF THE INVENTION

The field of the invention is that of the management of micropayment transactions.

More precisely, the invention relates to a system and process for managing micropayment transactions implementing at least one broker, at least one client, and at least one merchant of products and/or of services.

Micropayment is understood here to mean a payment of a restricted amount, for example from a few fractions of centimes to a few tens or hundreds of francs (or a restricted amount in any other currency of exchange). It may in particular implement an exchange of tokens constituting an electronic transaction currency.

### STATE OF THE ART

The emergence of systems for micropayment and/or macropayment transactions implemented by way of communication networks, such as for example the worldwide Internet network, has raised the problem of the security of the transactions between clients and merchants, as well as of the security of the information exchanged in the course of these transactions.

In particular, one of the main problems of the security of transactions is the possibility of a merchant and/or a client of the system copying a token (or any other unit of currency of exchange) and of using it fraudulently for two separate transactions.

Numerous systems for managing electronic transactions have been proposed for solving this security problem, or at the very least for enhancing the security of the transactions. These systems are for example described in the work entitled “Electronic Payment Systems” published by Artech House in 1997, and co-authored by Donal O'Mahony, Michael Peirce, and Hitesh Tewari.

This work distinguishes between, on the one hand, systems for electronic payment by cash, such as the Ecash system developed by the DigiCash (registered trademarks) company, the CAFE project (standing for Conditional Access for Europe), or the NetCash CyberCoin or Mondex (registered trademarks) systems.

On the other hand, it mentions specific micropayment systems, such as Millicent, SubScrip, PayWord, MicroMint or else the iKP (registered trademarks) micropayment protocol.

In all the existing cash-based electronic payment systems, the security of the transactions is ensured by way of intensive use of cryptography, both symmetric and asymmetric. Thus, in the Ecash system (registered trademark), for example, numerous encrypted signatures of the bank and/or of the broker, which are associated with numerous decryption computations, are implemented so as to verify that each token flowing around the system has been used once and only once. Moreover, the bank and/or the broker carry out a systematic verification of the validity of the tokens, in the course of each of the transactions, by comparing the serial number of the tokens with a voluminous database encompassing all the serial numbers of all the tokens issued by the system.

A drawback of this technique of the prior art is therefore that the security of the transactions is ensured at the cost of implementing very numerous computations and encryptions, which overload the system and make it expensive, and hence unsuitable for micropayment transactions.

Another drawback of this technique of the prior art is that it is necessary to manage a considerable database encompassing all the serial numbers of the tokens issued by the system, this being expensive and complex.

In the CAFE project (standing for Conditional Access for Europe), for example, the security of the transactions is ensured by virtue of the implementation of terminals which are resistant to any falsification, and of complex cryptography. An observer, which protects the interests of the bank and/or of the broker, is integrated into each client's wallet. Its role is to ensure the validity of all the transactions undertaken by a client, so much so that the latter may not implement a transaction without obtaining the agreement of the observer.

A drawback of this technique of the prior art, as well as of the other systems for electronic payment by cash such as NetCash, CyberCoin or Mondex (registered trademarks), is the weightiness of the cryptography implemented, as well as the complexity of the terminals used, which are unsuitable for micropayment transactions.

The work “Electronic Payment Systems” moreover presents systems for managing micropayment transactions.

The system called Millicent (registered trademark) implements three participants: a client, a merchant, and a broker. Tokens, specific to a given merchant, are exchanged in the course of micropayment transactions. A client can acquire tokens of a given type, which enable him to pay a particular merchant, via a broker, in exchange for a macropayment. These tokens are then stored in the client's purse.

The micropayment transaction management system called SubScrip (registered trademark), on the other hand, does not involve any bank or broker. A client uses a macropayment process to open a temporary prepaid account with a given merchant.

A drawback of these two techniques of the prior art is that they are not suitable for the transactions implemented between a single client and a plurality of merchants. Specifically, in the Millicent (registered trademark) system, a client has to acquire as many different tokens as the number of merchants from which he wishes to purchase a product and/or a service. Likewise, in the SubScrip (registered trademark) system, a client has to open a prepaid account with each of the merchants with which he wishes to undertake micropayment transactions.

The PayWord (registered trademark) system alleviates this drawback by granting the client a credit authorization, with a broker and/or a bank, which thereafter guarantees payment to the merchants.

It is clearly apparent that a drawback of this technique of the prior art is the lack of security of the transactions, in particular in respect of the broker and/or the bank, a large number of purchases being operable by a client without the latter having the necessary funds in his bank account.

In the iKP micropayment transaction management protocol, the security of the transactions is enhanced with respect to the PayWord (registered trademarks) system, in particular by virtue of authentication of the client with a merchant, prior to any transaction.

A drawback of this technique is that such authentication requires numerous exchanges of messages which weigh upon and slow down the protocol, and make the transactions expensive.

The efficiency of the micropayment transactions of the MicroMint system is greater than that of the iKP (registered trademarks) protocol, but this efficiency is achieved at the expense of the security of the micropayment transactions. A broker and/or a bank supplies tokens to a client, which can be used at all the merchants. No verification of the validity of the tokens is undertaken in the course of the transactions, permitting repeated use of the same token.

A drawback of this technique of the prior art is therefore that the transactions are not secure, neither for the client, nor for the merchant, who may receive tokens which are invalid, having already been used previously, as payment.

There are therefore numerous systems and processes for managing micropayment transactions, exhibiting various levels of security and complexity, in which a client is either provided with an electronic purse, or with a credit authorization, or with a prepaid account with a merchant. However, no system or protocol which is simple to implement, and exhibits satisfactory security in respect of the various participants in the transactions (broker, client, merchant) is currently known.

The objective of the invention is in particular to alleviate these drawbacks of the prior art.

More precisely, an objective of the invention is to provide a system and process for managing micropayment transactions which are simple, easy to use and inexpensive to implement.

### DESCRIPTION OF THE INVENTION

To this end, the invention relates to a system for managing micropayment transactions comprising at least one broker, at least one client and at least one merchant of products and/or of services, said transactions implementing exchanges of tokens.

According to the invention, in such a system, each of said clients has available at least two separate areas for storing tokens, these areas for storage corresponding to two client purses: one main purse and one secondary purse. The main purse can comprise tokens supplied by the broker to the client, and the secondary purse can comprise tokens supplied by the merchant to the client.

Thus, the invention is based on an entirely novel and inventive approach to the management of micropayment transactions. Specifically, a client can thus be provided with a reliable area for storing tokens, containing tokens whose validity is assured, and with a credit-like area for storing tokens, this credit being granted to the client by one or more merchants, and being able to furthermore contain information about the transactions performed with the merchant or merchants.

The security of the transactions is thus enhanced for the client, who is assured of being provided with a resource of valid tokens, namely his main purse, without fearing, for example, that these tokens have been fraudulently copied and used twice by a merchant. The client is also advantageously provided with a complementary resource of tokens, corresponding to a credit which he can use at one or more merchants, namely his secondary purse.

According to an advantageous characteristic of the invention, each of said merchants has available at least two different areas for storing tokens.

Preferably, at least a first area for storing tokens of the merchant corresponds to a purse of the merchant and at least a second area for storing tokens of the merchant corresponds to a deposit file of the merchant. The purse of the merchant can comprise tokens supplied by the broker to the merchant, and the deposit file can comprise tokens supplied by the client to the merchant.

Thus, at the merchant's, the tokens originating from the broker are separated from the tokens supplied by the client or clients, so that the validity of the contents of the merchant's purse is guaranteed, the security of the transactions being thus enhanced.

The invention also relates to a process for managing micropayment transactions in a system as described above.

According to one aspect of the invention, in the course of the payment for a product and/or for a service procured by the client from the merchant, the client sends the merchant a first number P of tokens, corresponding to the price of the product and/or of the service;

the first number P of tokens originating from the first area for storing tokens of the client, corresponding to his main purse and capable of containing tokens supplied by the broker, if said main purse contains a quantity of tokens which is greater than or equal to P;

if said main purse contains a quantity of tokens X, which is less than P, the client sends:

X tokens originating from said main purse; and

P-X tokens originating from the second area for storing tokens of the client, corresponding to his secondary purse and capable of containing tokens supplied by the merchant;

and the merchant stores said first number P of tokens sent in his second area for storing tokens, corresponding to the deposit file.

The client thus gives priority to the use of the tokens which he has acquired from the broker to pay the merchant, but he can also make a part or the whole of the payment with the aid of the tokens contained in the secondary purse, which represent a credit which he can use at the merchant's. The validity of the tokens supplied by the client to the merchant not being guaranteeable, the latter does not store the tokens received in his purse, but in a deposit file.

In an advantageous embodiment of the invention, when the merchant wishes to reimburse a sum to the client, the process comprises the steps consisting in:

withdrawing a second number of tokens corresponding to said sum, from said first storage area of the merchant corresponding to his purse;

verifying that said second number, added to the tokens of the secondary purse of the client, does not exceed a predetermined maximum;

said maximum not being exceeded, storing said second number in the secondary purse of the client; otherwise:

interrupting the process, and reimbursing the client by implementing a macropayment process; or

dispatching a message to the client requesting him to empty his secondary purse so as to be able to be reimbursed.

Thus, the reimbursement transaction is made secure, on the one hand, through the use of tokens extracted from the merchant's purse (the client is thus ensured of the validity of the tokens which he receives from the merchant), and on the other hand, through the storing of the tokens received in the secondary purse of the client (the main purse remains reserved for the tokens whose validity is guaranteed directly by the broker).

Moreover, the invention advantageously makes provision for the maximum number of tokens which can be stored in the secondary purse of the client to be limited, so as to put a ceiling on the credit granted by the merchant or merchants to a given client. Such an arrangement therefore makes it possible to reduce the risks incurred by the merchant, and in particular the risks of fraudulent payment.

Advantageously, such a process furthermore comprises a step of transferring tokens from the secondary purse of the client to his main purse, comprising the following substeps:

the client requests the broker to transfer the tokens contained in the secondary purse to the main purse;

the broker verifies the validity of said request of the client, on the one hand, and of said tokens contained in the secondary purse, on the other hand;

said validity being verified, the broker transfers the tokens from said secondary purse to the main purse.

Thus, according to the invention, such a step of transferring the tokens from the secondary purse to the main purse is always accompanied by a validating of the tokens by the broker. According to a preferred embodiment of the invention, such a transfer step is implemented in the course of each transaction between the client and the broker, so as to guarantee regular verification of the validity of the tokens supplied by the merchant or merchants.

Preferably, when the client wishes to purchase tokens from the broker, the process comprises the following steps:

the broker sends the purchased tokens to the main purse;

the secondary purse containing tokens, the broker verifies the validity of said tokens, and, said tokens being valid, transfers said tokens from the secondary purse to the main purse.

Advantageously, when said merchant wishes his purse to be debited by the value of N tokens so as to credit them to his bank account, N being a predetermined integer number, the process comprises the following steps:

the broker verifies that the purse of the merchant contains at least N tokens;

verification being performed, and the deposit file containing M tokens, M being a predetermined integer number, the broker credits the bank account of the merchant with the value of (N+M) tokens, empties said deposit file, and removes N tokens from the purse of the merchant.

Thus, in addition to the operation requested by the merchant, the broker systematically carries out a verification and emptying of the deposit file, this being especially advantageous for the merchant.

Preferably, when the client wishes his bank account to be credited with the value of at least one token contained in his main purse, and his secondary purse containing at least one token, the broker carries out a step of verification of the validity of said at least one token contained in the secondary purse and, in case of positive verification, transfers said at least one token from the secondary purse to the main purse.

Thus, in addition to the operation requested by the client, the broker automatically verifies the contents of the secondary purse so as to transfer the contents thereof to the main purse, this being advantageous for the client.

In an advantageous embodiment of the invention, the broker, the merchant and the client each own a pair of asymmetric keys, said keys making it possible to sign the transactions implementing a bank account of the client and/or of the merchant.

Specifically, the transactions implementing a bank account of one of the parties handle “real” money, and not electronic currency such as tokens. They consequently require strong properties of nonrepudiation, should there be a dispute between the broker and one of the other parties, which are guaranteed by the use of asymmetric cryptography.

Advantageously, a message exchanged in the course of one of said transactions between two parties is authenticated with the aid of a derived symmetric key, determined from a master key and from the identity of at least one of said two parties.

Thus, in the case of a transaction in which a client participates, the key is derived from the identity of the client. In the case where the transaction involves the broker and the merchant, the key is derived from the identity of the merchant. In this way, it is not necessary to store a master key in a terminal of the client, and only a few master keys need to be stored in an appliance of the merchant.

Preferably, each of said transactions implements a specific symmetric key, said specific key being usable only for one of the transactions belonging to the group comprising:

the broker sends at least one token to the main purse of the client;

the broker sends at least one token to the purse of the merchant;

the merchant requests payment for a product and/or for a service from the client;

the client pays the merchant for a product and/or a service;

the client presents a proof of purchase to the merchant;

the merchant reimburses the client;

the broker repurchases at least some of the tokens of the client;

the broker repurchases at least some of the tokens of the merchant.

In this way, each micropayment transaction using a different key, the security of the process is strongly enhanced: specifically, the compromising of just one key will not compromise the entire process, but only the transaction corresponding to the compromised key.

According to an advantageous technique of the invention, said symmetric keys owned by the client and/or the merchant can be used only for one of the following operations:

the production of a datum making it possible to authenticate the origin and the integrity of a message exchanged in the course of one of said transactions;

the verification of said datum, so as to guarantee nonrepudiation of said datum.

The selective use of a key for the production or the verification of an authentication datum (MAC, “Message Authentication Code”) which makes it possible to guarantee the nonrepudiation of the datum, is made possible, according to a preferred embodiment of the invention by the storing of the keys of the client (irrespectively of the merchant) on a smart card of the client (respectively of the merchant). The impossibility of modifying the executable code of a smart card makes it possible to selectively delegate a key to the production or to the verification of the authentication datum.

Thus, as long as a key is not compromised, a MAC cannot have been generated other than by just one smart card, thus preventing a client from repudiating a payment for example. If, contrary to the technique implemented according to the invention, the symmetric keys could be used both for the generation and for the verification of the MACs, at least two smart cards (respectively one with the client and one with the merchant) could have generated a given MAC, and this would allow a client to refute a payment.

The invention relates to a client terminal, in a system for managing micropayment transactions as described previously, said transactions implementing exchanges of tokens between at least one broker and/or at least one merchant of products and/or of services and/or said client. The terminal comprises at least two different areas for storing tokens, corresponding to at least one main purse and to at least one secondary purse, the main purse can comprise tokens supplied by the broker to said client, and the secondary purse can comprise tokens supplied by the merchant to said client.

Advantageously, said two storage areas are located in a secure processor contained in the terminal or in a data support which can be read by the terminal.

In particular, such a data support can be a smart card, or any other secure data support.

The invention also relates to a merchant appliance in a system for managing micropayment transactions as described previously, said transactions implementing exchanges of tokens between at least one broker and/or at least one client, and/or said merchant, the appliance comprising at least two separate areas for storing tokens.

Preferably, two of said storage areas are a purse of the merchant and a deposit file of the merchant, the purse of the merchant being able to comprise tokens supplied by the broker to the merchant, and the deposit file being able to comprise tokens supplied by the client to the merchant.

### BRIEF DESCRIPTION OF THE DRAWINGS

Other characteristics and advantages of the invention will become more clearly apparent on reading the following description of a preferred embodiment, given by way of simple illustrative and nonlimiting example, and of the appended drawings, among which:

FIG. 1 presents a schematic of the transactions implemented according to the invention, when a client wishes to purchase a product and/or service from a merchant;

FIG. 2 presents a schematic of the transactions implemented between the various participants of FIG. 1, when a merchant wishes to reimburse a client;

FIG. 3 illustrates the transactions implemented between the various participants of FIG. 1, when a client and/or a merchant wishes to transfer the contents of his purse to his bank account.

### DETAILED DESCRIPTION OF EMBODIMENTS OF THE INVENTION

The general principle of the invention is based on the existence of two separate areas for storing tokens, for each client of a system for managing micropayment transactions. These two storage areas correspond to a main purse of the client, containing tokens supplied by a broker, and a secondary purse, in which the client stores the tokens which he has received from one or more merchants, for example for reimbursement for an unavailable item of merchandise, or as winnings from a game in which the client has participated.

With each of these two purses is associated a predetermined maximum sum corresponding to the maximum number of tokens which each of the purses can contain.

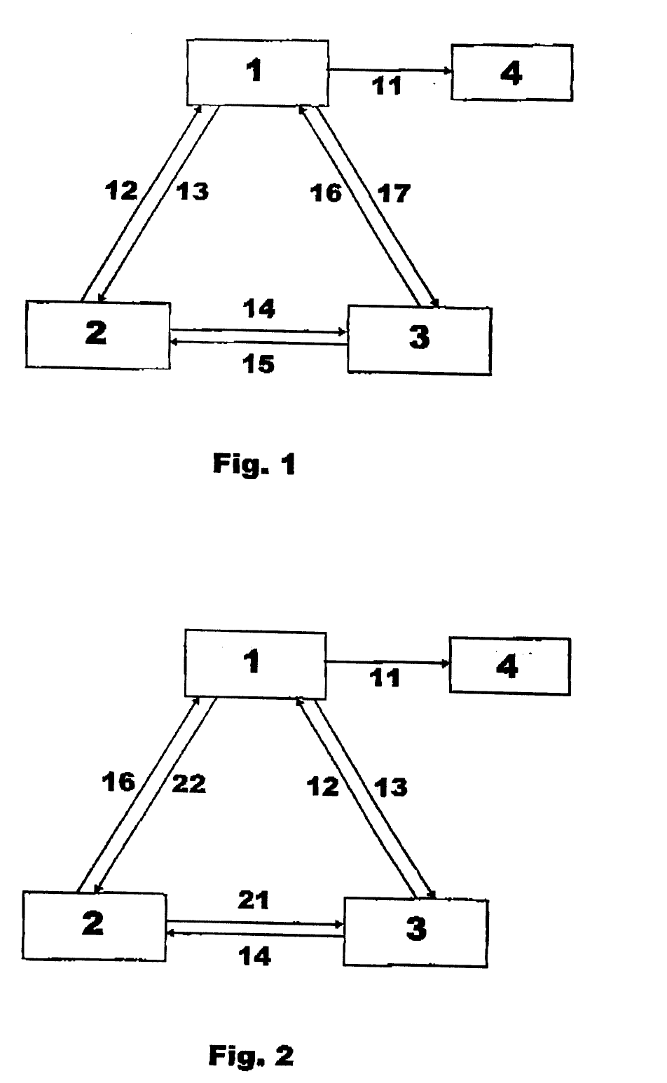

Presented in conjunction with FIG. 1 is an embodiment of a micropayment transaction from a client 2 to a merchant 3, implemented, for example, through the intermediary of the worldwide Internet network.

To participate in a micropayment transaction, a client 2 uses a terminal, which may for example consist of two entities;

a smart card, used as secure means of data storage, and as means of authentication of the client 2. It is also possible to envisage this smart card having other functionalities, such as the management of the payment for television channels;

a multimedia digital decoder, comprising a smart card reader, and being able to communicate with a merchant 3 and a broker 1.

The client 2 can also implement a micropayment transaction according to the invention from any other type of suitable terminal (integrating for example the means of the smart card).

It will be noted that the block referenced 4 in FIG. 1 represents, for the sake of simplification, the bank of the client 2 and/or of the merchant 3. It is of course possible to envisage the merchant 3 and the client 2 being clients of the same bank 4 or of different banks 4.

Before any purchase, if his main purse and his secondary purse are empty, the client 2 has to acquire tokens from a broker 1. With this in mind, the client 2 dispatches, in the course of a step referenced 12, to the broker 1, an authorization to debit a bank account belonging to him in a bank 4, by an amount equal to the value of the tokens which he wishes to procure. For example, the client 2 signs an electronic check to the broker 1. The payment authorization sent by the client 2 gives the broker 1 all the necessary information for obtaining payment from the bank 4 of the client 2.

After having been paid by the bank 4, the broker 1 dispatches the desired tokens to the client 2 in the course of a step referenced 13.

In the course of steps not represented in FIG. 1, the client 2 selects the product and/or the service which he wishes to procure from the merchant 3, fills in an order form and dispatches it to the merchant 3. For example, the client 2 fills in an order form accessible from the website of the merchant 3. The merchant 3 then requests payment for the product and/or the service from the client 2.

To participate in a micropayment transaction according to the invention, it is possible to envisage the merchant 3 being provided with an appliance comprising several entities of the type:

one or more smart cards, and/or secure processors, used as secure data storage areas, and/or as means of authentication of the merchant 3, and/or as data encryption means;

a server, capable of handling the transactions implemented simultaneously with several clients 2.

The client 2 then carries out the micropayment for the product and/or service ordered in the course of the step referenced 14.

With this in mind, the client 2 sends the merchant 3 a number of tokens corresponding to the value of the product and/or of the service procured, which he will have withdrawn from his main purse if the latter contains sufficient tokens. In the converse case, the client 2 withdraws tokens from his main purse, until the latter is empty. If need be, the client 2 withdraws the lacking number of tokens from his secondary purse so as to carry out the micropayment.

After receipt of the micropayment, the merchant 3 delivers to the client 2 the product and/or the service ordered in the course of a step referenced 15. The tokens which he has received from the client 2 are stored in a deposit file.

The merchant 3 may then wish for a bank account which he has in a bank 4 to be credited with an amount corresponding to the value of the tokens received from the client 2. It is also possible to envisage the merchant 3 keeping the tokens received from the client 2, until he has a predetermined number of tokens, before crediting his bank account with the corresponding value.

The merchant 3 then presents the tokens contained in the deposit file, or some of these tokens, to the broker 1, in the course of a step referenced 16. The merchant 3 can also present, furthermore, tokens contained in a purse. The broker 1 verifies the validity of the tokens received. After verification, in the course of a step referenced 11, the broker 1 sends the bank 4 a mandate for transfer to the account of the merchant 3, of a sum corresponding to the value of the valid tokens received.

The broker 1 also sends the merchant 3, in the course of a step referenced 17, a copy of the transfer mandate addressed to the bank 4, so as to assure him that his bank account will indeed be credited.

Described hereinafter, in conjunction with FIG. 2, are the transactions implemented according to the invention when a merchant 3 wishes to reimburse a client 2, or send him a number of tokens corresponding, for example, to the winnings of the client 2 in respect of a game and/or a lottery in which he has participated at the merchant's 3.

The merchant 3 begins by filling his purse with tokens, which he procures from the broker 1. Specifically, only the tokens which he purchases from the broker 1 can be used to reimburse a client 2. The merchant 3 cannot use any tokens which might be stored in his deposit file to reimburse the client 2, this presenting additional security for the client 2.

With this in mind, the merchant 3 dispatches, in the course of a step referenced 12, an authorization for payment to the broker 1. This authorization supplies the broker 1 with all the necessary information for requesting the bank 4 of the merchant 3 to withdraw money from a bank account of the merchant, in the course of a step referenced 11.

The broker 1 then dispatches to the merchant 3, in the course of a step referenced 13, a number of tokens corresponding to the sum which he has received as payment, from the bank 4. These tokens are stored, by the merchant, in his purse. For example, the purse of the merchant is contained in a smart card.

The client 2 supplies the merchant 3 with a proof of purchase, in the course of a step referenced 21, so as to affirm that he should indeed be reimbursed, or so as to present, for example, the winning lottery ticket which he holds.

The merchant 3 can then carry out the micropayment of the client 2, in the course of a step referenced 14. He sends the client 2 a number of tokens corresponding to the sum to be reimbursed, or to the value of the winnings of the client 2.

It is possible to envisage that, prior to this sending, the merchant 3 verifies that the number of tokens which he wishes to send to the client 2 is less than the maximum number of tokens which can be stored in the secondary purse of the client, or that the sum of this number of tokens and of any tokens already contained in the secondary purse of the client does not exceed the authorized maximum number of tokens. In the converse case, it is for example possible to envisage the merchant 3 reimbursing the client 2 by implementing a macropayment process which is not the subject of the present invention. It is also possible to envisage the merchant 3 dispatching a message to the client 2 requesting him to empty his secondary purse, so as to be able to be reimbursed, or so as to obtain his winnings.

These tokens are stored in the secondary purse of the client 2, which may also be contained in a smart card for example. The validity of these tokens is verified in the course of the first transaction implemented, subsequently, between the client 2 and the broker 1. The client 2 then presents the tokens contained in his secondary purse to the broker 1, in the course of a step referenced 16.

After verification of the validity of the tokens, the broker 1 sends the number of valid tokens to the client 2 in the course of a step referenced 22. These verified tokens are then stored by the client 2 in his main purse.

According to a variant embodiment, the client 2 may prefer that a bank account which he has in a bank 4 be credited with an amount corresponding to the value of the valid tokens. The broker then dispatches in the course of a step referenced 11 a transfer mandate to the bank 4 of the client 2. It is then possible to envisage that he sends the client 2 a copy of this transfer mandate so as to assure him that his bank account will indeed be credited.

The validity of the tokens contained in the secondary purse of the client 2 can moreover be verified by the broker 1 in the course of each transaction involving the client 2 and the broker 1.

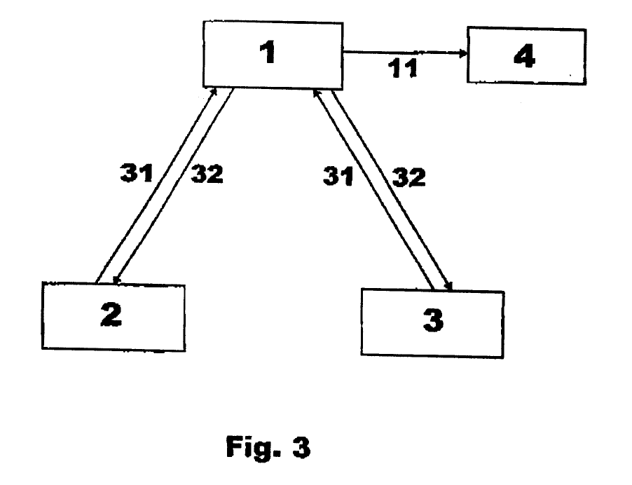

Presented in conjunction with FIG. 3 are the transactions implemented when the client 2 or the merchant 3 wishes the broker 1 to repurchase from him all or some of the tokens contained in his purse.

In the course of a step referenced 31, the client 2 or the merchant 3 sends the broker 1 an order to repurchase a number N of tokens.

In the course of a step referenced 32, the broker 1 then sends the client 2 and/or the merchant 3 a confirmation of repurchase of the N tokens.

In the course of a step referenced 11, the broker moreover dispatches a transfer mandate to the bank 4 of the client 2 and/or of the merchant 3; so that the bank account of the client 2 and/or of the merchant 3 is credited with a sum corresponding to the value of the number N of repurchased tokens.

These N tokens may originate from the main purse and/or secondary purse of the client 2, as well as from the purse and/or from the deposit file of the merchant 3. The tokens originating from the secondary purse of the client 2 and from the deposit file of the merchant 3 are verified by the broker 1, who determines their validity before crediting the bank accounts of the client 2 and/or of the merchant 3 with a sum corresponding to their value.

It will be noted that the invention aids the traceability of the tokens, owing to the existence of only four possible paths for a given token. Such traceability advantageously makes it possible to enhance the security of the transactions undertaken between the various participants, namely the broker 1 and/or the client 2, and/or the merchant 3.

Specifically, each token is created by the broker 1, and returned to the latter at the end of its life, according to one of the following mechanisms:

in the course of a micropayment transaction, a token is issued by the broker 1, sent to the client 2 and then to the merchant 3, who then sends it back to the broker 1;

in the course of a reimbursement, a token is issued by the broker 1, sent to the merchant 3 and then to the client 2, who then sends it back to the broker 1;

in the case of repurchase of the contents of the purse of the client 2, a token created by the broker 1, and then stored in the main purse of the client 2, is sent back to the broker 1;

finally, a token created by the broker 1, and stored in the purse of the merchant 3, can be repurchased by the broker 1.

It is possible to envisage, according to a preferred embodiment of the invention, that an audit of tokens be implemented in the following manner:

when he sends tokens to a given participant (the client 2 and/or the merchant 3), the broker 1 records the total number of tokens consigned to this participant, and updates this number when he repurchases tokens from the latter;

when he verifies the validity of tokens, the broker 1 knows the identity of the participant to which he has initially consigned these tokens. He records the total number of tokens which he has verified in respect of this participant;

the broker 1 compares this total number of verified tokens with the total number of consigned tokens. If the relevant participant is the merchant 3, the total number of verified tokens must be less than the total number of consigned tokens. If the relevant participant is the client 2, the total number of verified tokens must be less than the sum of the total number of consigned tokens and of the maximum number of tokens which can be stored in the secondary purse of the client 2. In the converse case, the invention advantageously makes it possible to determine that tokens have been created by the relevant participant (the client 2 and/or the merchant 3).

According to the invention, a cryptography process can moreover be implemented in order to secure at least some of the exchanges between the broker 1 and/or the merchant 3 and/or the client 2.

For example, all the transactions involving a bank account of the client 2 and/or of the merchant 3 are protected with the help of asymmetric cryptography. Specifically, such transactions implement “genuine” sums of money (as opposed to a number of tokens), and must therefore exhibit strong properties of nonrepudiation.

According to a preferred embodiment of the invention, all the other transactions will be protected by symmetric cryptography.

For all the transactions illustrated by FIGS. 1 to 3, implementing a bank account, the broker 1 and/or the merchant 3 and/or the client 2 use a pair of asymmetric keys which they hold.

To authenticate a message exchanged in the course of a transaction (not implementing a bank account), between two participants (the broker 1 and/or the client 2 and/or the merchant 3), use is preferably made of a symmetric key, derived from the identity of one of the two participants and a master key. For example, in the course of a transaction involving the client 2, the key is derived from the identity of the client. In the course of a transaction involving the merchant 3 and the broker 1, a key is derived from the identity of the merchant 3.

According to a preferred embodiment of the invention, each symmetric key is used specifically for a predetermined type of transaction and/or of verification, such as:

the storage of tokens in the main purse of the client 2 by the broker 1;

the storage of tokens in the purse of the merchant 3 by the broker 1;

the request of the merchant 3 for payment from the client 2;

the micropayment to the merchant 3 for a purchase from the main and/or secondary purse of the client 2;

the validation of a proof of purchase of the client 2;

the reimbursement of the client 2 by the merchant 3;

the repurchase of the tokens of a client 2 by the broker 1;

the repurchase of the tokens of a merchant 3 by the broker 1;

etc.

According to a preferred embodiment of the invention, a system for managing error messages is also implemented in the course of all the transactions illustrated by FIGS. 1 to 3.

It is for example possible to envisage that error messages are issued to the client 2 and/or to the broker 1 and/or to the merchant 3 if an error arises in the course of a transaction, such as:

a data authentication error;

in the course of a micropayment, the client 2 does not have the sufficient number of tokens to pay the merchant 3;

the proof of purchase presented by the client 2 to the merchant 3 is not valid, in the course of a reimbursement transaction;

in the course of a validation of tokens by the broker 1, some tokens are not valid;

etc.

1. A system for managing micropayment transactions comprising at least one broker (1), at least one client (2) and at least one merchant of products and/or of services (3), said transactions implementing exchanges of tokens, characterized in that each of said clients (2) has available at least two separate areas for storing tokens, at least one first area for storing tokens corresponding to at least one main purse and at least one second area for storing tokens corresponding to a secondary purse, said main purse being able to comprise tokens supplied by said broker (1) to said client (2), and said secondary purse being able to comprise tokens supplied by said at least one merchant (3) to said client (2).

2. The system according to claim 1, characterized in that each of said merchants (3) has available at least two different areas for storing tokens.

3. The system according to claim 2, characterized in that at least a first area for storing tokens of said merchant corresponds to a purse of said merchant (3) and at least a second area for storing tokens of said merchant corresponds to a deposit file of said merchant (3), said purse of said merchant (3) being able to comprise tokens supplied by said broker (1) to said merchant (3), and said deposit file being able to comprise tokens supplied by said at least one client (2) to said merchant (3).

4. A method for managing micropayment transactions in a system according to claim 3, characterized in that in the course of the payment for a product and/or for a service procured by said client (2) from said merchant (3), said client (2) sends (14 FIG. 1) said merchant (3) a first number P of tokens, corresponding to the price of said product and/or of said service;
said first number P of tokens originating from the first area for storing tokens of said client, corresponding to his main purse and capable of containing tokens supplied by said broker (1), if said main purse contains a quantity of tokens which is greater than or equal to P;
if said main purse, contains a quantity of tokens X, which is less than P, said client sends:
X tokens originating from said main purse; and
P-X tokens originating from the second area for storing tokens of said client, corresponding to his secondary purse and
capable of containing tokens supplied by said merchant (3); and in that said merchant (3) stores said first number P of tokens sent in his second area for storing tokens, corresponding to said deposit file.

5. The method according to claim 4, characterized in that, said merchant (3) wishing to reimburse (14-FIG. 2) a sum to said client (2), said method comprises the steps consisting in:
withdrawing a second number of tokens corresponding to said sum, from said first storage area of said merchant (3) corresponding to his purse;
verifying that said second number, added to the tokens of said secondary purse of said client, does not exceed a predetermined maximum;
said maximum not being exceeded, storing said second number in said secondary purse of said client; otherwise:
interrupting said process, and reimbursing said client by implementing a macropayment process; or
dispatching a message to said client requesting him to empty his secondary purse so as to be able to be reimbursed.

6. The method according to any one of claims 4 or 5, characterized in that it furthermore comprises a step of transferring tokens from said secondary purse to said main purse, comprising the following substeps:
said client (2) requests said broker (1) to transfer said tokens contained in said secondary purse to said main purse;
said broker (1) verifies the validity of said request of said client (2), on the one hand, and of said tokens contained in said secondary purse, on the other hand;
said validity being verified, said broker (1) transfers said tokens from said secondary purse to said main purse.

7. The method according to any one of claims 4 to 6, characterized in that said client (2) wishing to purchase tokens from said broker (1), said process comprises the following steps:
said broker (1) sends (13) said purchased tokens to said main purse;
said secondary purse containing tokens, said broker (1) verifies the validity of said tokens, and, said tokens being valid, transfers said tokens from said secondary purse to said main purse.

8. The method according to any one of claims 4 to 7, characterized in that, said merchant (3) wishing his purse to be debited by the value of N tokens so as to credit them to his bank account, N being a predetermined integer number, said method comprises the following steps:
said broker (1) verifies that said purse of said merchant (3) contains at least N tokens;
verification being performed, and said deposit file containing M tokens, M being a predetermined integer number, said broker (1) credits (11) the bank account of said merchant (3) with the value of (N+M) tokens, empties said deposit file, and removes N tokens from said purse of said merchant.

9. The method according to any one of claims 4 to 8, characterized in that, said client (2) wishing his bank account to be credited with the value of at least one token contained in said main purse, and said secondary purse containing at least one token, said broker (1) carries out a step of verification of the validity of said at least one token contained in said secondary purse and, in case of positive verification, transfers said at least one token from said secondary purse to said main purse.

10. The method according to any one of claims 4 to 9, characterized in that said broker (1), said merchant (3) and said client (2) each own a pair of asymmetric keys, said keys making it possible to sign said transactions implementing a bank account of said client (2) and/or of said merchant (3).

11. The method according to any one of claims 4 to 10, characterized in that a message exchanged in the course of one of said transactions between two parties is authenticated with the aid of a derived symmetric key, determined from a master key and from the identity of at least one of said two parties.

12. The method according to any one of claims 4 to 11, characterized in that each of said transactions implements a specific symmetric key, said specific key being usable only for one of the transactions belonging to the group comprising:
said broker (1) sends (13-FIG. 1, 22-FIG. 2) at least one token to said main purse of said client (2);
said broker (1) sends (13-FIG. 2) at least one token to said purse of said merchant (3);
said merchant (3) requests payment for a product and/or for a service from said client (2);
said client (2) pays (14-FIG. 1) said merchant (3) for a product and/or a service;
said client (2) presents a proof of purchase (21) to said merchant (3);
said merchant (3) reimburses (14-FIG. 2) said client (2);
said broker (1) repurchases at least some of the tokens of said client (2);
said broker (1) repurchases at least some of the tokens of said merchant (3).

13. The method according to any one of claims 11 and 12, characterized in that said symmetric keys owned by said client (2) and/or said merchant (3) can be used only for one of the following operations:
the production of a datum making it possible to authenticate the origin and the integrity of a message exchanged in the course of one of said transactions;
the verification of said datum, so as to guarantee nonrepudiation of said datum.

14. A client terminal, in a system for managing micropayment transactions, said transactions implementing exchanges of tokens between at least one broker (1) and/or at least one merchant (3) of products and/or of services and/or said client (2), characterized in that it comprises at least two different areas for storing tokens, corresponding to at least one main purse and to at least one secondary purse, said main purse being able to comprise tokens supplied by said at least one broker (1) to said client (2), and said secondary purse being able to comprise tokens supplied by said at least one merchant (3) to said client (2).

15. The client terminal according to claim 14, characterized in that said two storage areas are located in a secure processor contained in said terminal or in a data support which can be read by said terminal.

16. A merchant equipment in a system for managing micropayment transactions, said transactions implementing exchanges of tokens between at least one broker (1) and/or at least one client (2), and/or said merchant (3), characterized in that it comprises at least two separate areas for storing tokens.

17. The merchant equipment according to claim 16, characterized in that two of said storage areas are a purse of said merchant (3) and a deposit file of said merchant (3), said purse of said merchant (3) being able to comprise tokens supplied by said broker (1) to said merchant (3), and said deposit file being able to comprise tokens supplied by said at least one client (2) to said merchant (3).
